(19) United States
(12) Patent Application Publication
(10) Pub. No.: US 2005/0208367 A1
(43) Pub. Date: Sep. 22, 2005

(54) Carrier substrate for an electrode layer of a fuel cell and method for the production thereof

(75) Inventor: Thomas Hoefler, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke AG, Muenchen (DE)

(21) Appl. No.: 11/134,274

(22) Filed: May 23, 2005

Related U.S. Application Data
(63) Continuation of application No. PCT/EP03/11376, filed on Oct. 13, 2003.

(30) Foreign Application Priority Data
Nov. 22, 2002 (DE) 102 54 495.6

(51) Int. Cl. H01M 4/86; B05D 5/12; H01M 8/02

(52) U.S. Cl. 429/44; 427/115; 429/34

(57) ABSTRACT

A fuel cell including a carrier substrate for an electrode layer of a cathode-electrolyte-anode unit is provided. The substrate is made of a corrosion-resistant material, is permeable to a combustible gas or oxygen, and is integrally joined to a metallic frame or plate. An electrically conductive material is supplied on the carrier substrate to provide maximum conductivity across the substrate. Preferably, the corrosion-resistant material is a chromium steel with an aluminum oxide or silicon oxide layer, while the electrically conductive material may be Ni, Cu, or Co. Wires, wire pieces, or chips made of the electrically conductive material can be integrated into the permeable structure. Alternatively, the electrically conductive material may be particles impregnated in the carrier substrate as a powder, slurry, or suspension. The electrically conductive material may also be applied in the form of a dissolved salt which is converted at start-up if the fuel cell.

This application is a continuation of International Patent Application No. PCT/EP2003/011376, filed Oct. 13, 2003, the entire disclosure of which is incorporated herein by reference. Priority is claimed based on German Patent Application No. 102 54 495.6, filed Nov. 22, 2002.

### BACKGROUND AND SUMMARY OF THE INVENTION

This invention relates to a method for manufacturing a fuel cell having a carrier substrate for an electrode layer of a cathode-electrolyte-anode unit, said substrate consisting of a structure that is permeable for the combustion gas or for air-oxygen, is integrally joined to a metallic frame or to a metallic bipolar plate and is electrically conducting; the permeable structure is formed by a matrix of a corrosion-resistant material and a suitable electrically conducting material incorporated into this structure forms the most continuous possible current paths in the carrier substrate. For the technical background, in addition to the DE 43 40 153 C1, reference is made to the International Patent Application PCT/EP02/06453, which is not prepublished, and to the German Patent Application 102 38 859, which is not prepublished.

Various methods are already known for manufacturing solid oxide fuel cells (SOFC) which are capable of generating electric power by introducing combustion gas and air-oxygen. For example, the ceramic layers of solid oxide fuel cells that form the electrodes of the fuel cell may be manufactured individually by sintering green compacts of the respective layers (namely the cathode, electrolyte and anode), as is the case with a fuel cell according to the DE 43 40 153 C1 cited above.

Alternatively, the individual electrode layers may be sprayed in succession onto so-called carrier substrates, which may be formed by a metallic matrix or by ceramic substrates. For this spray application, suitable thermal spray methods may be used, such as vacuum plasma spraying, atmospheric plasma spraying, flame spraying or others. The so-called carrier substrate may form the supporting structure of the fuel cell, in particular when the electrode layers are designed in thin-film technique. For this carrier substrate, porous and thus gas-permeable materials which are also electrically conducting at the same time (and therefore are usually metallic) are used, in particular in the case of vacuum-plasma-sprayed fuel cells, in order to permit the supply of product, the removal of product and electric current conduction within the fuel cell (see PC/EP02/06453 cited above, for example).

Carrier substrates that can be used for such solid oxide fuel cells manufactured by sintering then consist mostly of anode or cathode material, depending on whether it is an anode- or cathode-supported fuel cell. These carrier substrates of anode or cathode material advantageously have a very good corrosion resistance and usually also an adequate electric conductivity. However, it is a disadvantage that these ceramic carrier substrates cannot be integrally joined to metallic bipolar plates or inserted into metallic frames, although this is desirable in particular for construction of a stable fuel cell stack (see, for example, the German Patent Application 102 38 859) cited above.

For example, a so-called cassette design with a welded carrier substrate for reducing the sealing surfaces in a fuel cell stack (=stack of individual fuel cells) can be implemented to advantage with metallic carrier substrates, whereby instead of the weld mentioned above, a soldered joint or an adhesive bonded joint may be used, i.e., an integral joint in general. Metallic carrier substrates may be formed by metal foams, for example, or nonwovens of metallic fibers (shaved or cut) or they may be composed of knit or superfine woven fabrics. Essentially a wide variety of techniques are also possible for manufacturing these molded articles, e.g., the methods of powder metallurgy. However, these carrier substrates may also be designed as die-molded products of metal shavings or metal powder or they may consist of wire mesh or wire cloth.

However, the corrosion resistance of the metallic material may be a problem, especially because the carrier substrates are highly porous components which naturally have a large surface area (for example, the pore size may be in range of 0.1 μm to 80 μm with a porosity of 10-90%). Essentially, this corrosion problem can be solved if suitable elements are added by alloying with the metallic material; these added elements preferably control development of an oxide layer that forms on the surface of the material during operation of the fuel cell. Although the usual oxide layers such as Al₂O₃ form highly corrosion-resistant protective layers, they also have the disadvantage of functioning as electric insulators, which absolutely prevents functioning of the fuel cell. Other oxide layers such as Cr₂O₃ and Cr, Mn spinels at least have a low electric conductivity but then, as highly porous components, they have only a moderate to poor corrosion resistance.

The International Patent Application PCT/EP02/06453 which has already been cited and was not prepublished also mentions that the permeable structure may be at least partially coated with a corrosion-resistant material and that an electrically conducting mass may be introduced to establish the electric contact.

A novel method of manufacturing a fuel cell, will now be demonstrated. With this method it is possible to manufacture a corrosion-resistant fuel cell which is at the same time reliably characterized by a high internal electric conductivity.

This object is achieved according to this invention by forming the permeable structure in that a matrix is formed from wires or a nonwoven or a foam structure or the like and a cover layer is applied to it; the electrode layer of the cathode-electrolyte-anode unit is then deposited on this cover layer, said cover layer being formed from powder grains or shavings or foam of a corrosion-resistant material into which an electrically conducting material is subsequently introduced. Advantageous refinements are the subject of the subclaims.

The so-called permeable structure of the carrier substrate, which is permeable for the combustion gas or the air-oxygen, consists of a corrosion-resistant matrix which can be joined to the bipolar plate (or a metallic frame or the like) and into which an electrically conducting material suitable for the fuel cell, e.g., SOFC, is introduced. This electric material should form the most continuous possible current paths within the so-called permeable structure and/or in the carrier substrate. For example, nickel and/or a suitable nickel compound may be considered for such a material. In addition, however, the electrically conductive material may also consist essentially of copper or cobalt or cerium or gadolinium or the like. In addition to zirconium, scandium, yttrium, it is also possible to use oxides of these elements as well as suitable mixtures, plus noble metals such as ruthenium or platinum. Moreover, the elements added for current conduction may advantageously also function as catalysts for internal reforming of the fuel in the fuel cell.

With regard to the aforementioned joinability and/or the possibility of an integral joint between the carrier substrate and/or the permeable structure or matrix and a metallic bipolar plate (or a metallic frame in general), this integrally joined connection may be embodied as a soldered connection or as a weld or an adhesive joint. The required corrosion resistance may be achieved with chrome steels, for example, which form aluminum oxide as a protective layer, i.e., the matrix may consist of a substance which forms aluminum oxide (e.g., Aluchrom®). However, other corrosion-resistant steels or alloys may also be used if they form aluminum oxide or silicon oxide in particular as the corrosion-prevention layer. It should be pointed out here that the matrix can achieve its corrosion resistance in particular also by the fact that it forms the respective protective layers, i.e., is oxidized in practical terms, during operation of the fuel cell or during a pretreatment step.

Thus, a corrosion-resistant material and/or a material that creates corrosion resistance is used for the so-called permeable structure and/or the matrix, and the required electric conductivity of this carrier substance is created by additionally introducing into this matrix and/or into the permeable layer an electrically conductive material suitable for a fuel cell (SOFC). The permeable structure consists of a matrix formed by wires or a nonwoven or a foam structure or the like, and wires or pieces of wires or shavings consisting of an electrically conductive material may be integrated into the matrix or foam structure as the electrically conductive material. Then a so-called cover layer is applied to this matrix, and the electrode layer of the cathode-electrolyte-anode unit can be deposited on this cover layer. This cover layer is also formed by powder grains or shavings or foam of a corrosion-resistant material into which the electrically conductive material, e.g., in the form of particles, is then introduced subsequently.

Said current paths in the carrier substrate may thus be manufactured by introducing conductive particles into the corrosion-resistant matrix and/or into the cover layer thereon, i.e., into the structure that is permeable for the combustion gas or the air-oxygen. Particles, e.g., of nickel or nickel compounds (or other materials already mentioned above) may be used as the conductive particles or additives in particular for the cover layer, so that then continuous current paths can develop as well as possible. The electric current should thus be able to flow continuously on such current paths from the cathode-electrolyte-anode unit to the bipolar plate of the fuel cell. The electric conduction resistance in the fuel cell is then minimal.

To also prevent interdiffusion during sintering of nickel with the substrate metal, e.g., steel, it may be advantageous if one of the components is preoxidized before the actual sintering and/or if the sintering conditions (e.g., the oxygen partial pressure) are adjusted so that a thin oxide layer is already formed during sintering. This oxide layer which is formed on the nickel particles, for example, automatically dissolves, as desired, on startup of the fuel cell (namely at higher temperatures due to reduction by hydrogen, which is supplied as a fuel to the fuel cell).

For the case when a knit or woven fabric is used as the matrix, it is advantageous in particular that the wires of the knit or woven mesh protrude into the applied cover layer. It has already been mentioned that a combination of corrosion-resistant wires forming a suitable protective layer with electrically conductive wires suitable for the fuel cell operation is especially advantageous for introducing current paths into a matrix composed of wire structures. Similarly, in the case of nonwovens (as matrix), corrosion-resistant and electrically conducting wire pieces and/or shavings may be combined with one another.

The cover layer of the carrier substrate may be sintered, e.g., as a slip-cast film, on the matrix and/or the permeable substructure. For adhesion of the cover layer to the substructure, it has proven advantageous if the knit or woven fabric is first immersed in the slip-casting solution or provided with it, e.g., by a printing roller or some other coating technique. In this way, the wires are wetted with the powder from the slip-casting solution and the cover layer sinters better, in particular when it is weighted down during the sintering operation. However, cover layers can also be manufactured by screen printing, wet powder spraying, etc.

In addition, it is possible to produce said current paths by impregnating the so-called permeable structure, in particular the matrix, with either a saline solution or with a slip (a suspension or the like) of a material capable of conducting electricity. One possibility of introducing electrically conducting materials into an inert matrix may thus consist of impregnating this matrix with a solution or dispersion (e.g., with a dissolved salt) of an electrically conductive material suitable for operation of the fuel cell or a material that can be converted by an aftertreatment into an electrically conductive form. For example, a soluble nickel compound, e.g., nickel acetate or nickel nitrate, may be used for this. However, it is also possible to produce the electrically conductive component in the form of a slurry or suspension of metal particles. This so-called slip solution can be applied or introduced, e.g., by screen printing, by spraying, by siphoning or by immersion to or into the permeable structure (matrix and/or cover layer) or introduced. Furthermore, it is also possible to introduce the material capable of conducting electricity in the form of melt into the so-called permeable structure.

These methods are especially advantageous because in this way the electrically conductive material can also be introduced into a permeable structure joined to said metallic frame or to the bipolar plate. For example, a nickel salt solution may be introduced into the matrix in a controlled manner without providing its welded edge with nickel. This is advantageous in particular inasmuch as nickel is known to be able to cause a change in the thermal expansion coefficient and the corrosion resistance of steel.

Thus in summary, particles which produce the electric conductivity and/or corresponding, preferably continuous, current paths in said structure which is permeable for combustion gas or air-oxygen, may be introduced in the form of a powder or slurry or suspension or melt into the permeable structure. However, it is also possible to impregnate the permeable structure with a solution of the electrically conducted material, in particular a metal compound, whereby it should be pointed out that converting the “dissolved” metal compound (in particular a metal salt) to the conductive form can definitely be shifted to the startup process of fuel cell. In the case of nickel as the electrically conductive material, the hydrogen in the combustion gas reduces the nickel ions in the metallic nickel. A corresponding reduction is also conceivable before starting operation of the fuel cell, e.g., by treating the carrier substrate with hydrogen, hydrazine or other suitable reducing agents.

Alternatively, electrically conductive material may also be introduced into the permeable structure, e.g., by electroplating, but the permeable structure must already have a certain electric conductivity, or by sputtering or by PVD (physical vapor deposition). It should also be pointed out that the so-called permeable structure can be oxidized only after electroplating, i.e., the corrosion prevention layer can be formed then, which thus makes the structure corrosion resistant. In addition, all the methods listed here are suitable for a said matrix as well as for a cover layer applied to it which then together form said permeable structure.

If the matrix of the cover layer is produced by sintering a slip-cast film of a metal powder, then a nickel salt and/or another suitable metal salt may also be added to this slip-casting solution to establish the electric conductivity. In this case, it is advisable if the so-called matrix consists of a combination of corrosion resistant and electrically conductive materials.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a scanning electron micrograph of a fuel cell structure in accordance with an embodiment of the present invention.

FIG. 2 shows a scanning electron micrograph of a section through a cover layer of the fuel cell structure of FIG. 1, before oxidation.

FIG. 3 shows a scanning electron micrograph of a section through a cover layer of the fuel cell structure of FIG. 1, after oxidation.

### DETAILED DESCRIPTION

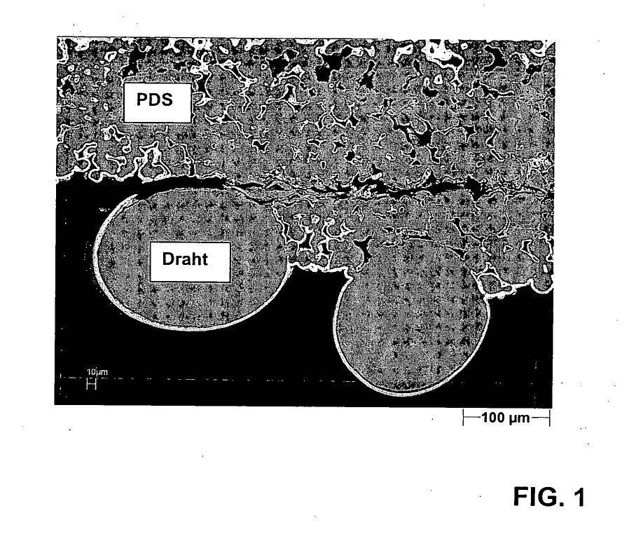

FIG. 1 shows a detail of the so-called permeable structure, namely the transition area between a matrix formed from wires (“wire”) and a cover layer (“PDS”) applied to it whereby both the matrix, i.e., the wires as well as the cover layer formed by powder grains consist of chrome steel, namely FeCrAlY in this case. Both the material of the matrix, i.e., the wires and the material of the cover layer are electroplated with nickel to achieve the desired electric conductivity. The areas shown as gray or dark gray in FIG. 1 denote the chrome steel while the white areas denote the electrically conductive nickel layers. The black areas denote pores and/or holes in the so-called permeable structure which ensure the gas permeability required for functioning of the fuel cell. FIG. 1 shows a state without a corrosion-preventing layer, i.e., oxidation of the chrome steel which ensures corrosion resistance has not yet occurred in this state. As already described, such oxidation which creates the corrosion resistance may also be performed after electroplating with the conductive nickel layer.

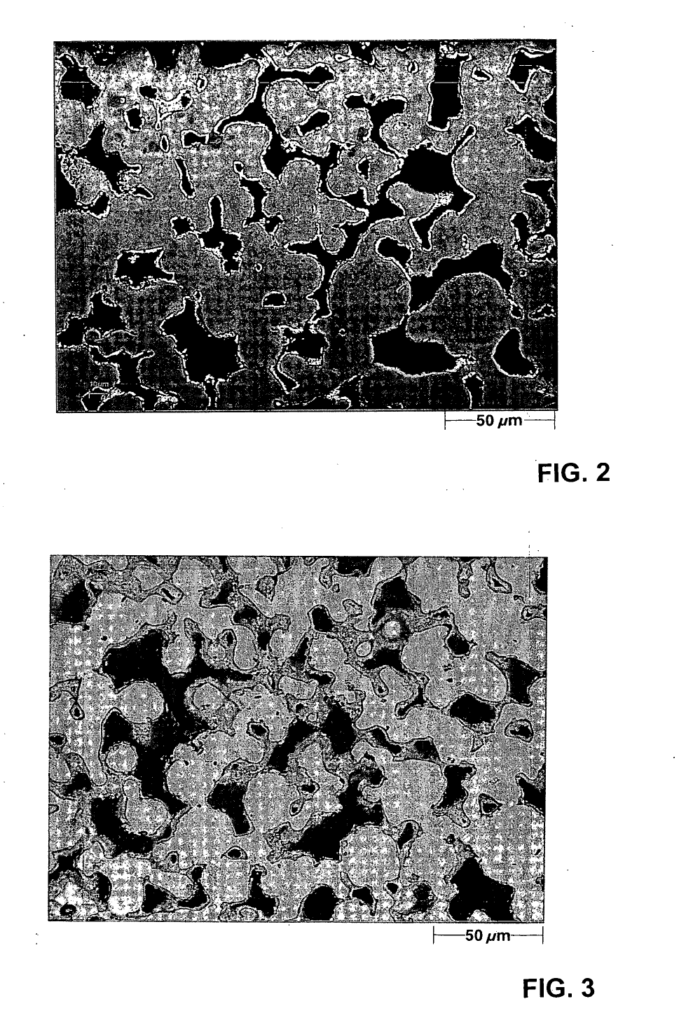

FIG. 2 and FIG. 3 show a section through the cover layer alone, enlarged again in comparison with FIG. 1, FIG. 2 also showing it before oxidation of the chromium-iron material, with the colors being the same as those in FIG. 1. FIG. 3 shows the state after oxidation, i.e., after development of the corrosion-preventing layer, but here again the darkest areas denote holes and/or pores which are responsible for the required gas permeability.

It is optionally also possible to combine two of the production methods described here, namely the introduction of electrically conductive particles into a corrosion-resistant matrix and impregnating same with a solution of a conductive material. It is also possible to design carrier substrates in the form of perforated sheet metal or films (e.g., the unprepublished German Patent Application 102 38 859 cited above) as a corrosion-resistant matrix and create the electric conductivity by impregnating this carrier substrate with a solution or a slip with a conductive material. Then the concept to be described can be used for anode-protected fuel cells as well as for cathode-protected fuel cells, namely for solid oxide fuel cells produced by thermal coating and also by sintering. Use for other concepts in addition to solid oxide fuel cells is also conceivable, but it should be pointed out that a number of details may be designed in deviation from the above explanation without going beyond the content of the patent claims.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Method for manufacturing a fuel cell having a carrier substrate of a cathode-electrolyte-anode unit, comprising the steps of:
forming a carrier substrate matrix from at least one of corrosion-resistant metal wires, metal fibers and metal foam, the matrix being integrally joined to a metallic frame or plate;
applying a cover layer to the carrier substrate matrix, the cover layer being formed from at least one of metal powder grains, metal shavings and metal foam, and including an electrically conducting material which forms continuous current paths across the carrier substrate matrix; and
applying an electrode layer onto the cover layer,
wherein the carrier substrate formed by the matrix and the applied cover layer is gas permeable.

2. Method for manufacturing a fuel cell as claimed in claim 1, wherein the electrolyte conductive material is introduced in the form of particles.

3. Method for manufacturing a fuel cell as claimed in claim 2, wherein the electrolyte conductive particles are introduced in the form of at least one of a powder, a slurry, a suspension and a melt.

4. Method for manufacturing a fuel cell as claimed in claim 1, wherein the electrically conductive material is introduced to the permeable structure by impregnating the permeable structure with a solution or melt of one of an electrically conductive material and a material which is rendered electrically conductive after a transformational aftertreatment.

5. Method for manufacturing a fuel cell as claimed in claim 4, wherein the material which is rendered electrically conductive after a transformational aftertreatment is a metal salt, and the transformational aftertreatment is the startup process of the fuel cell.

6. Method for manufacturing a fuel cell as claimed in claim 1, wherein the electrically conductive material is introduced into the permeable structure by at least one of electroplating, sputtering and physical vapor deposition.

7. Method as claimed in claim 1, wherein the electrically conductive material consists essentially of one of Ni, Cu, Co, Ce, Gd, Zr, Y, Sc, Ru and Pt.

8. Method as claimed in claim 1, wherein the corrosion-resistant metal is a chrome steel formed with one of an aluminum oxide and silicon oxide corrosion-preventing layer.

9. Method as claimed in claim 1, wherein corrosion-resistant metal is a metal which is oxidized to form a corrosion-preventing layer with increased corrosion resistance during at least one of operation of the fuel cell or a pretreatment step.

10. Method for manufacturing a fuel cell as claimed in claim 1, wherein at least one of wires, wire pieces and shavings of the electrically conductive material are integrated into the carrier substrate matrix.

11. Method for manufacturing a fuel cell as claimed in claim 1, wherein the integrally joined connection between the corrosion-resistant material and the metallic frame or plate is formed by one of soldering, welding and gluing.

12. Method for manufacturing a carrier substrate of a cathode-electrolyte-anode fuel cell, comprising the steps of:
forming a carrier substrate matrix from at least one of corrosion-resistant metal wires, metal fibers and metal foam, the matrix being integrally joined to a metallic frame or plate; and
applying a cover layer to the carrier substrate matrix, the cover layer being formed from at least one of metal powder grains, metal shavings and metal foam, and including an electrically conducting material which forms continuous current paths across the carrier substrate matrix,
wherein the carrier substrate formed by the matrix and the applied cover layer is gas permeable.

13. A fuel cell having a carrier substrate of a cathode-electrolyte-anode unit, comprising:
a carrier substrate matrix, the matrix comprising at least one of corrosion-resistant metal wires, metal fibers and metal foam,
a metallic frame or plate integrally joined to the carrier substrate matrix;
a cover layer applied to the carrier substrate matrix, the cover layer comprising at least one of metal powder grains, metal shavings and metal foam, and including an electrically conducting material which forms continuous current paths across the carrier substrate matrix; and
an electrode layer applied on to the cover layer,
wherein the carrier substrate formed by the matrix and the applied cover layer is gas permeable.

14. A carrier substrate of a cathode-electrolyte-anode fuel cell, comprising:
a carrier substrate matrix, the matrix comprising at least one of corrosion-resistant metal wires, metal fibers and metal foam, and
a metallic frame or plate integrally joined to the carrier substrate matrix;
a cover layer applied to the carrier substrate matrix, the cover layer comprising at least one of metal powder grains, metal shavings and metal foam, and including an electrically conducting material which forms continuous current paths across the carrier substrate matrix;
wherein the carrier substrate formed by the matrix and the applied cover layer is gas permeable.
